(19) United States
(12) Patent Application Publication
(10) Pub. No.: US 2026/0330338 A1
(43) Pub. Date: Oct. 22, 2026

(54) AI GOLF TRIP SERVICE SYSTEM UTILIZING BIG DATA

(71) Applicant: AGL, INC., Seoul (KR)

(72) Inventors: Jin Kook HWANG, Seoul (KR); Deok Yong KIM, Gyeonggi-do (KR)

(73) Assignee: AGL, INC., Seoul (KR)

(21) Appl. No.: 19/114,066

(22) PCT Filed: Jul. 27, 2023
(86) PCT No.: PCT/KR2023/010917

§ 371 Date: Mar. 21, 2025

(30) Foreign Application Priority Data
Sep. 22, 2022 (KR) 10-2022-0120135

(51) Int. Cl. G06Q 10/02; G06Q 30/0251; G06Q 30/0601

(52) U.S. Cl. CPC G06Q 10/026; G06Q 30/0271; G06Q 30/0631; G06Q 2220/00

(57) ABSTRACT

The present invention provides a golf trip service system. More specifically, the present invention relates an AI golf trip service system which provides a service platform in which various golf trip-related product suppliers register and trade their products, and enables accumulation and utilization of big data through the platform. According to an embodiment of the present invention, a golfer name record is assigned to a user who desires to use a service and an overall data process required to provide a golf trip service is processed on the basis of the assigned golfer name record so that big data is constructed, and the big data is not only collected and processed but also distributed, whereby a new type of service, which is not present in the conventional art, can be provided.

### TECHNICAL FIELD

The present disclosure relates to a golf trip service system, and particularly, to an AI golf trip service system which enables various golf trip-related product suppliers to register their products, provide their traded service platforms, and accumulate and use big data through the platforms.

### BACKGROUND ART

In order to use a golf service not only for long domestic trips but also for international travel, it is necessary to secure not only golf course tee times but also accommodations, transportation, and other related services in advance. Additionally, depending on the traveler's itinerary, restaurant reservations may be required.

Accordingly, in the case of a conventional golf-dedicated trip service based on the Internet that is now being served, similar to general sightseeing, a travel company that attempts to commercialize a golf trip plans and sells golf trip products which may be sold in a product unit, by first securing airline tickets distributed by airlines, determining schedules on the basis of the airline tickets, and combining and packaging reservation-available dates for local golf courses and accommodation companies.

That is, in general, a conventional golf trip product has a form in which when a product supplier for each product included in a travel schedule prepares and discloses products to be provided, a travel company, etc. plans and sells travel products by gathering the products or traveler checks and combines contents by directly searching for information on each product.

In this case, the travel product that is planned and sold by the travel company is not different from a common overseas trip product except that golf tee times are included in an activity schedule, and has a limit to the satisfaction of the needs of travelers who want various purposes and tastes because service quality depends on the capability of a travel company that plans travel products.

Specifically, a golf trip package that is now being served provides only a limited search function depending on the capability of each travel company with respect to each of accommodations, transportation, restaurants, and other travel products that are necessary for a golf trip, or makes it difficult for a traveler to selectively use a service that is suitable for his or her intention because most of products included in the golf trip package are previously designated and cannot be changed.

Furthermore, although relatively various choices are present and several products which may be selected by a traveler for each purpose are provided, a personal traveler feels a great deal of difficulty in determining a schedule and selecting a company because the traveler has to check the schedule one by one with respect to products uploaded by each travel product supplier, individually review product conditions, such as places and the number of persons, and perform a separate reservation procedure on each different company.

In particular, in the case of a system that sells the existing overseas golf trip product, more airline ticket information, more golf course information, and other product information need to be registered with conventional travel product sales system because subsequent schedules and companies need to be dependently determined on the basis of an airline ticket. However, multiple airlines, golf courses, and other companies already autonomously manage independent product sales systems. Accordingly, the system that sells the existing overseas golf trip product has a limit in that it does not provides a service in which products of various companies, which are registered with their product sales systems, are gathered and sold.

In particular, unlike a common sightseeing tour, a golf trip has a main purpose of golf. Suitable products need to be matched and gathered on the basis of the golf propensity of a traveler so that the traveler selects the suitable products. However, this is not enough to satisfy a sensitive golfer traveler because a system management side cannot determine information, such as the green states of all of local golf courses and a local weather condition at the very day of a travel schedule, one by one.

A prior document related to this case includes Korean Patent No. 10-2007995 (publication date: Oct. 21, 2019).

### DISCLOSURE

### Technical Problem

The present disclosure has been contrived to overcome the aforementioned limits, and has an object of constructing a platform which can collect, gather, and disclose airlines, accommodation companies, and product information from various travel product suppliers, in addition to golf course companies, online and can assign a golfer name record, that is, identification means of a new concept which can uniquely identify a user with respect to a golf trip case, and provide up to reservation and management functions from the sales of a golf trip product based on the golfer name record throughout the enterprise.

Furthermore, another object of the present disclosure is to collect and process data by actively using the golfer name records of multiple users through the platform, apply the data to a golf trip service, and also prepare a foundation on which accumulated big data for golf trips can be distributed.

### Technical Solution

In order to achieve the aforementioned objects, an AI golf trip service system using big data according to an embodiment of the present disclosure may include a terminal support unit configured to receive a service request related to a golf trip in response to a request from one or more user terminals and to transmit a response to the request, a golf course interoperation unit configured to collect golf course data, including one or more bookable golf course schedules, in real time from one or more golf course operating servers and to transmit one or more golf course data matched based on search of the user terminal, an airline interoperation unit configured to collect flight schedule data, including one or more bookable flight schedules, in real time from one or more airline servers and to transmit one or more flight schedule data matched with golf course data selected by a user as a reply, other product interoperation unit configured to collect travel products necessary for a travel destination in real time from one or more travel product company servers and to transmit one or more travel product data matched with the golf course data or the flight schedule data selected by the user as a reply, a reservation processing unit configured to generate one golf trip reservation process by combining one golf course data, one or more flight schedule data, or travel product data selected by the user, and a database configured to store information related to generated golf reservation process by using a golfer name record for each user as an identifier.

The user terminal may access the terminal support unit through a user interface provided by an application or web page mounted thereon. The application may include a search unit configured to request search from the terminal support unit through an input keyword and to receive the results of the search related to one or more golf courses, flights, or travel products, a reservation request unit configured to request reservations for one or more golf courses and other travel products other than the golf courses by transferring the selection of the user for the results of the search to the terminal support unit, and a reservation confirmation unit configured to request reservation completion details from the terminal support unit, receive a response to the request, and display the response, in response to a request from the user.

The golf course interoperation unit may include a golf data collection module configured to collect the golf course data, including places, locations, available tee times, and the number of persons, from one or more golf course servers that are managed in golf courses being open for business in each area or country in real time, a golf data provision module configured to provide the collected golf course data to the user terminal through the terminal support unit, and a golf course reservation module configured to request reservations for a corresponding golf course server when reservations for any one golf course are requested by the user terminal and to receive the results of the reservations from the golf course server.

The airline interoperation unit may include a flight schedule data collection module configured to collect flight schedule data, including hours of operations of flights including boarding times and the number of passengers allowed to board, from one or more airline servers that are managed in airlines being open for business in each area or country in real time, a flight schedule data provision module configured to extract one of more collected flight schedule data based on a schedule of the selected golf course data, among the collected flight schedule data, and to provide the extracted flight schedule data to the user terminal through the terminal support unit, and an airline ticket reservation module configured to request reservations for a corresponding airline server when reservations for any one flight are requested by the user terminal and to receive the results of the reservations from the airline server.

The reservation processing unit may include a record update module configured to sequentially record reservation histories on the golfer name record of a user who requests reservations when each interoperation unit receives a response to a reservation request, and an AI product recommendation module configured to recommend suitable flight schedule data and travel product data to the user terminal on the basis of a selected golf course with respect to a travel product that is able to be added to a travel schedule after the golf course is selected.

The database may include a travel information storage module configured to store travel information, including all of recordable histories that are generated from the start to the end of the golf trip, in the golfer name record by setting the travel information in association with the golfer name record, and a data storage module configured to store raw data generated in all of procedures related to the golf trip including the travel information and big data obtained by processing the raw data.

The AI golf trip service system may further include a learning unit configured to extract one Or more travel products corresponding to propensity information of each user based on travel information Of the user, which is recorded in association with the golfer name record through a machine learning algorithm, and to provide the one or more travel products to the AI product recommendation module.

The AI golf trip service system may further include a big data system configured to serve, as big data, data that are set and stored in association with the golfer name record. The big data system may include a collection unit configured to extract raw data that are set and stored in association with the golfer name record from a database or one or more supplier servers or to receive the raw data by requesting the raw data, a processing unit configured to generate distribution data having a tradable form by parsing, combining, and encrypting the collected raw data, and a distribution unit configured to provide the distribution data to the one or more supplier servers according to agreements based on a transaction range.

The collection unit may include a search module configured to search for and extract the raw data including one or more of user information, a golf tee time, and a golf course location, and a GNR matching module configured to identify the golfer name record set in association with the raw data and to collect anterior and posterior raw data collected as a field of one golfer name record.

The processing unit may include a classification module configured to classify the collected raw data according to data categories, a combination module configured to generate one unit distribution data by combining a plurality of data that are classified according to an identical category and that have a minimum unit, and an encryption module configured to perform encryption on one or more of a plurality of data pieces that form one unit distribution data.

The distribution unit may include a public setting module configured to determine whether to open a plurality of distribution data according to a preset public range, and a distribution module configured to transmit the classified distribution data to a corresponding supplier server or to provide a public API.

### Advantageous Effects

According to an embodiment of the present disclosure, there are effects in that a supplier can effectively trade its own golf trip products and a user can be provided with a golf trip reservation service that is most suitable for a current situation and intention because each golf trip product supplier including a golf course company is allowed to register various fields of golf trip products that are being served with a system and an optimal golf trip product and schedule are recommended for a user who tries to use a golf trip service by assigning a golfer name record to the user.

Furthermore, according to an embodiment of the present disclosure, there is an effect in that a new form of service that does not exist before can be provided because big data are constructed and distributed in addition to the collection and processing of the big data by processing an overall data process that is necessary to assign a golfer name record to a user who tries to use a service and to provide a golf trip service based on the golfer name record.

### BRIEF DESCRIPTION OF DRAWINGS

FIG. 1 is a diagram illustrating an AI golf trip service system for the collection, processing, and distribution of big data according to an embodiment of the present disclosure and a general system structure associated with the AI golf trip service system.

FIG. 2 is a diagram specifically illustrating the entire structure of the AI golf trip service system for the collection, processing, and distribution of big data according to an embodiment of the present disclosure.

FIG. 3 is diagram illustrating a golf trip reservation method by the AI golf trip service system for the collection, processing, and distribution of big data according to an embodiment of the present disclosure.

FIG. 4 is a diagram illustrating a method of collecting, processing, and distributing big data by the AI golf trip service system for the collection, processing, and distribution of big data according to an embodiment of the present disclosure.

FIGS. 5 to 8 are diagrams that exemplify reservation screens that are provided to a user terminal by the AI golf trip service system for the collection, processing, and distribution of big data according to an embodiment of the present disclosure.

### BEST MODE

Prior to a description, in the entire specification, unless explicitly described to the contrary, when any part “includes” or “comprises” another component, it indicates the further inclusion of other components, not the exclusion of other components. Furthermore, the term “. . . unit”, “. . . server”, or “. . . system” described in the specification means a unit for processing at least one function or operation, and the unit may be implemented by hardware, software, or a combination of hardware and software.

Furthermore, in this specification, the term “embodiment” means that the term plays a role as an example, an instance, or a diagram, but the object of the disclosure is not limited to such an example. Furthermore, although “comprising”, “including”, “having” and other similar terms are used, if such terms are used in the claims, the terms are comprehensively used in a way similar to a term “comprising” as an open transition word that does not exclude an arbitrary additional or another component.

Various schemes described in this specification may be implemented with hardware or software or may be implemented along with a combination of both hardware and software if appropriate. Likewise, the terms, such as “. . . unit”, “. . . server”, and “. . . system”, as those used in this specification, may be treated as an equivalent to a computer-related entity, that is, hardware, a combination of hardware and software, software, or software upon execution. Furthermore, each function implemented in the system of the present disclosure may be composed of a computer program in a module unit, may be recorded on a piece of physical memory, or may be distributed and recorded between two or more types of memory and a recording medium.

In the following description, a phrase indicative of an “AI golf trip service system using big data” according to an embodiment of the present disclosure may be expressed in various ways, such as an “AI golf trip system for the collection, processing, and distribution of big data”, an “AI golf trip reservation system”, and a “system”.

Hereinafter, an AI golf trip service system using big data according to a preferred embodiment of the present disclosure is described in detail with reference to the drawings.

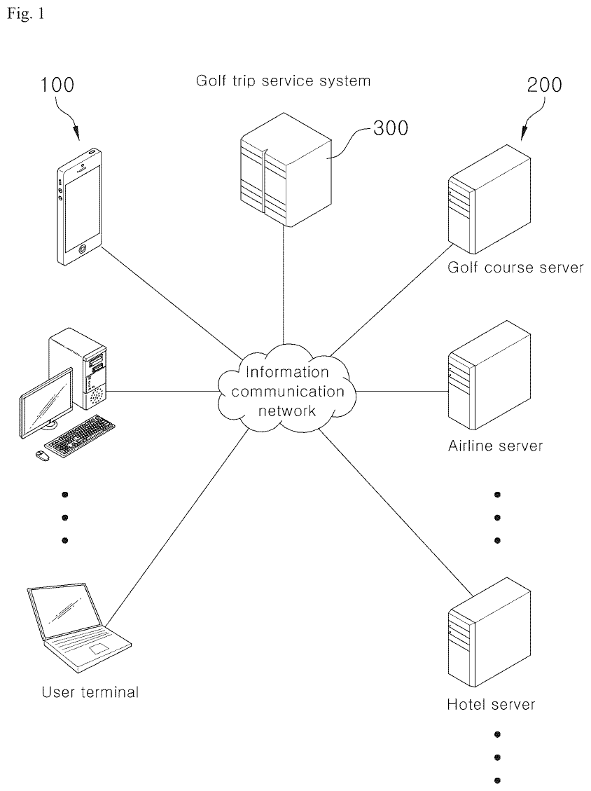

FIG. 1 is a diagram illustrating an AI golf trip service system for the collection, processing, and distribution of big data according to an embodiment of the present disclosure and general system structure associated with the AI golf trip service system.

Referring to FIG. 1, the AI golf trip service system for the collection, processing, and distribution of big data according to an embodiment of the present disclosure may perform access and booking processes through a user terminal 100 that is owned and used by a user who tries to use domestic and foreign golf course reservation services through the system of the present disclosure, and may provide a service through interoperation with supplier server 200 that provides various travel-related products, such as airlines and accommodation companies, in addition to domestic and foreign golf courses.

The user terminal 100 is a terminal device that is owned and used by a user who tries to access a golf trip reservation system of the present disclosure over an information communication network and perform a procedure for golf trip reservations, and may be a smartphone or stationary PC on which a known microprocessor has been mounted. The user terminal has a dedicated application or web browser that operates in conjunction with the system mounted thereon, and may perform tasks, such as search for golf courses, a request for reservations, the confirmation of reservations, etc.

A user who plans a golf trip does not look for travel products necessary for travel, such as airline tickets, accommodation companies, and vehicle rental, in addition to golf courses for each category one by one, does not check schedules, and does not individually perform a reservation procedure for each product, but performs a reservation procedure more conveniently and rapidly in way to sequentially review and check golf courses, flights, accommodation companies, etc. which are associated and recommended by a system 300.

All types of handheld-based wireless communication devices, such as a personal communication system (PCS), global system for mobile communications (GSM), personal digital cellular (PDC), a personal handyphone system (PHS), a personal digital assistant (PDA), international mobile telecommunication (IMT)-2000, code division multiple access (CDMA)-2000, W-code division multiple access (W-CDMA), a wireless broadband Internet (WiBro) terminal, a smartphone, a smart pad, and a tablet PC, and computing devices, such as stationary PC and a notebook, may be used the user terminal 100.

The supplier server 200 is a server apparatus that is managed by a supply company who sells various travel products related to domestic and foreign travel in addition to golf courses, and may be independently managed by each supplier.

The supplier is a term that collectively calls companies which provide various travel-related services in travel destinations, may be a golf course company, an airline, accommodation companies, a vehicle rental company, a restaurant company, etc., and may possess expert knowledge in providing specific knowledge related to a travel destination and a specialized service.

Each supplier may manage various supplier servers 200, such as an exemplified golf course server, an airline server, and a hotel server, for the reservation and management of travel services that are provided by companies. The supplier server 200 may operate in conjunction with the system 300 of the present disclosure over an information communication network.

Furthermore, the supplier server 200 may share data for travel services that are provided by each company, for example, golf course data, flight schedule data, and accommodation data, with the system 300 in real time, may perform a reservation process when receiving a reservation request from the system 300, and may transmit the results thereof to the system as a reply.

The supplier server 200 may be autonomously managed by a company, or may be managed and operated in conjunction through a virtual service of a cloud system in which the system 300 of the present disclosure is constructed.

The AI golf trip service system 300 for the collection, processing, and distribution of big data may provide a search service by collecting travel product information as an intermediary between a user and a supplier while operating in conjunction with the one or more user terminals 100 and supplier servers 200 over an information communication network, and may also perform a reservation process for associated travel products in addition to golf course reservations.

In general, the reservation systems of suppliers do not operate in conjunction with each other, and cannot share data for a reason, such as the security of sensitive data such as personal information. Accordingly, a user has to directly process services, such as golf course booking and the reservation of an airline ticket, from each supplier. Furthermore, some small companies do not manage an online booking service itself.

In order to overcome such an environmental limit, the system 300 according to an embodiment of the present disclosure is managed based on a global distribution system (GDS) for interoperation with servers that are managed by suppliers.

The GDS is a data processing system that provides processing and database functions which facilitate the management of travel-related services from multiple suppliers. User systems are connected to the GDS, and may support the search, sale, booking, purchase, and use of travel-related services, such as flights, accommodation rooms, or rental cars by using the GDS.

The AI golf trip service system 300 according to an embodiment of the present disclosure can manage a centralized database for continuously tracking travel services that are booked and used by a user because the AI golf trip service system is managed based on such a GDS.

In particular, the system 300 according to an embodiment of the present disclosure is a system that integrally books and manages multiple products necessary for golf trips, unlike a GDS that is widely applied to a specific field, for example, an air reservation system, and may further provide a function for matching association products, such as airline tickets and accommodations, in real time based on golf tee times including dates and times, a function for checking whether real-time product reservations have been paid, a control function for the real-time completion, modification, and addition of tee times, a database standardization function according to real-time central control over an affiliate company, etc.

Furthermore, the system 300 according to an embodiment of the present disclosure defines a golfer name record (GNR) as an identifier for identifying data in subsequent data collection, processing, and utilization processes in addition to data related to travel reservations, and processes a process relating to data based on the GNR.

According to the GNR, data including information on a personal golf trip schedule in addition to personal information, such as the name and age of a user, may be accumulated and recorded on a database association field.

According to an embodiment of the present disclosure, the system 300 may operate in conjunction with the supplier server 200 in order to manage the sales and use of multiple golf trip services that continuously occur. The system 300 may manage the reservation, progress, etc. of travel products that are identified based on a GNR through interactions with management processes, such as airlines, hotels, rental cars, and restaurant companies, based on the GNR. For interoperation between such systems, the system 300 may distribute an API to each supplier server 200. The supplier server 200 may share travel product information registered with each server through the API. Accordingly, the system 300 can transmit a response to search by collecting information and recommend travel products to a user based on the GNR.

An open network, such as the Internet, in addition to closed networks such as a local area network (LAN) and a wide area network (WAN), as known data communication networks, may be used as information communication network for interoperation with the supplier server 200 in addition to the user terminal 100. The Internet may mean a global open computer network structure that provides a TCP/IP protocol and several services that are present in an upper layer thereof, that is, a hypertext transfer protocol (HTTP), Telnet, a file transfer protocol (FTP), a domain name system (DNS), a simple mail transfer protocol (SMTP), a simple network management protocol (SNMP), a network file service (NFS), and a network information service (NIS). Furthermore, an example of a wireless communication network, any one, among technical standard or communication methods (e.g., global system for mobile communication (GSM), long-term evolution (LTE), LTE advance (LTE-A), code division multiple access (CDMA), wideband CDMA (WCDMA), a universal mobile telecommunications system (UMTS) , a wireless broadband (WiBro), or global system for mobile communications (GSM), and 5G for mobile communication, may be used, but the present disclosure is not limited thereto.

According to the aforementioned structure, the AI golf trip service system for the collection, processing, and distribution of big data according to an embodiment of the present disclosure can provide a user with a golf reservation service having a more advanced form by allowing the user to conveniently prepare a golf trip according to his or her intention and taste based on a GNR, collecting travel products from various companies that are associated with each other, and managing and operating a reservation case through a golfer name record.

Hereinafter, the structure of the AI golf trip service system for the collection, processing, and distribution of big data according to an embodiment of the present disclosure is described in detail with reference to the drawings.

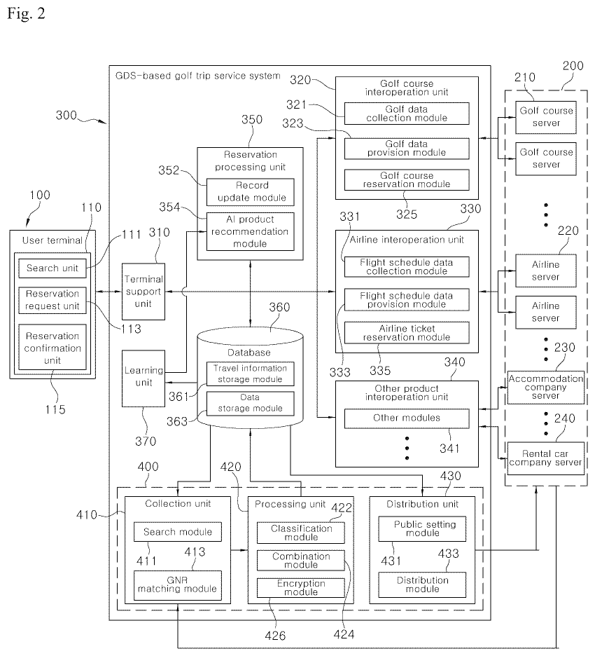

FIG. 2 is a diagram specifically illustrating the entire structure of the AI golf trip service system for the collection, processing, and distribution of big data according to an embodiment of the present disclosure. In the following description, components and modules that constitute the system may each be a computer program that is implemented by a known programming language, may be implemented in a form in which each component or module is executed by a microprocessor, may be stored in a readable and writable recording medium, and may be mounted on a computing device.

Furthermore, the AI golf trip service system for the collection, processing, and distribution of big data according to the present disclosure may be managed in a virtual server apparatus that is provided by a commercialized cloud system, and may provide automated golf trip reservation services to one or more user terminals that are accessed thereto over information communication networks.

Referring to FIG. 2, the AI golf trip service system 300 for the collection, processing, and distribution of big data according to an embodiment of the present disclosure may include a terminal support unit 310 that receives a service request related to a golf trip in response to a request from the one or more user terminals 100 and that transmits a response to the request, a golf course interoperation unit 320 that collects golf course data including one or more bookable golf course schedules from one or more golf course servers 210 in real time and that transmits one or more golf course data matched based on the search of the user terminal as replies, an airline interoperation unit 330 that collects flight schedule data including one or more bookable flight schedules from the one or more airline servers 220 in real time and transmits one or more flight schedule data matched with golf course data selected by a user as replies, other product interoperation unit 340 that collects travel products necessary for travel destinations from one or more travel product company servers 230 and 240 in real time and that transmits one or more travel product data matched with golf course data or flight schedule data selected by a user as replies, a reservation processing unit 350 that generates one golf trip reservation process by combining one golf course data, one or more flight schedule data, or travel product data selected by a user, and a database 360 that stores information related to a generated golf reservation process by using a golfer name record for each user as an identifier.

The terminal support unit 310 may provide a golf trip reservation service that is requested by a user online while operating in conjunction with the user terminal 100 that is accessed thereto through an application 110 or a web browser.

The structure of the user terminal 100 therefor is described in detail. The user terminal 100 may access the terminal support unit 310 through a user interface that is provided by the application 110 mounted thereon or a web page.

In this case, the application 110 may include a search unit 111 that requests search from the terminal support unit 310 through an input keyword and that receives the results of search related to one or more golf courses, flights, or travel products, a reservation request unit 113 that requests reservations for one or more golf courses and other travel products in addition to the golf courses by transferring a user's choice for the results of the search to the terminal support unit 310, and reservation confirmation unit 115 that requests reservation completion details from the terminal support unit 310 in response to a request from a user and that displays a received response to the request.

The search unit 111 may receive a keyword from a user through a device I/O mounted on the user terminal 100, and may request search by transferring the keyword to the terminal support unit 310. The user may keyword-search for a golf course including a desired area, country, and date based on a travel destination, a schedule, etc. Through the search function. The search unit 111 may provide the keyword to the terminal support unit 310, may extract golf course data for one or more golf courses registered with the system 300, and may transmit the golf course data to the search unit 111 as a reply.

The reservation request unit 113 may receive any one of one or more golf courses displayed on the user terminal 100, which is selected by a user, and may request reservations for the selected golf course from the terminal support unit 310. Specifically, the reservation request unit 113 may receive a golf course that is to be included in a travel schedule that is selected by the user, and may then receive a selected airline ticket based on flight schedule data corresponding to a golf course reservation date. Furthermore, the reservation request unit 113 may receive accommodations, a rental car, restaurant, etc. selected by the user, and may request reservations for each travel product by transferring the results of the selection to the terminal support unit 310 when the selection by the user is completed.

When the reservation process is completed after the reservation request by the reservation request unit 113, the reservation confirmation unit 115 may receive the results of the reservations from the terminal support unit 310, and may display the results of the reservations on a screen. Accordingly the user can confirm the history, the schedule, etc. of the travel service that has been booked by the user.

According to the aforementioned structure, the terminal support unit 310 may provide the user terminal 100 with functions, such as search, reservations, and confirmation for the use of a travel service.

The golf course interoperation unit 320 may collect and store golf course data in the database 360 in real time while operating in conjunction with the golf course servers 210 that are managed in areas or a plurality of domestic and foreign golf courses through the GDS, and may transmit golf course data for one or more golf courses corresponding to a keyword in response to a request from the terminal support unit 310.

As components for implementing the aforementioned function, the golf course interoperation unit 320 may include a the golf data collection module 321 that collects golf course data including places, locations, available tee times, and the number of persons from one or more golf course servers managed by golf courses being open for business in each area or country in real time, a golf data provision module 323 that provides collected golf data to the user terminal 100 through the terminal support unit 310, and a golf course reservation module 325 that requests reservations from a corresponding golf course server 210 when receiving a request for reservations for any one golf course from the user terminal 100 and that receives the results of the reservations from the golf course server 210.

The golf course data collection module 321 may collect golf course data, including information on places for tee times at golf courses, the number of available persons and times, etc., that is, travel products registered with a corresponding server, from a plurality of golf course servers. The collected golf course data may be stored in the database 360 for each golf course.

The golf course data provision module 323 may provide the collected golf course data to the user terminal 100 in response to a request from the terminal support unit 310. The terminal support unit 310 may transfer a received keyword to the golf course data provision module 323. In response thereto, the golf course data provision module 323 may extract one or more suitable golf course data from the collected golf course data by analyzing the keyword, and may provide the one or more suitable golf course data to the terminal support unit 310.

The golf course data provision module 323 may provide the collected multiple golf course data to the user terminal 100 through the terminal support unit 310. The system 300 of the present disclosure enables a user to check and book a bookable golf course and the location, facility, etc. of the golf course through keyword search online with respect to registered golf courses.

When reservations by the reservation processing unit 350 are performed, the golf course reservation module 325 may receive information on a golf course, tee times, the number of persons, etc., which are selected by a user, may request reservations for a corresponding case by providing the information to the golf course server 210, may receive the results of the reservations from the golf course server 210, and may provide the results of the reservations to the user terminal 100 through the terminal support unit 310.

In particular, according to an embodiment of the present disclosure, each golf course server 210 can autonomously receive and process the booking of golfers. Accordingly, a reservation process may be synchronized and processed through the golf course reservation module 325, the history of a case whose reservations have been completed may be shared with the golf course interoperation unit 320 in real time.

Furthermore, when the selection of a golf course is completed, the system 300 may support a purchase service for an airline ticket, that is, another travel product that needs to be booked in association with corresponding golf course reservations.

As a component therefor, the airline interoperation unit 330 may collect and store flight schedule data in the database 360 in real time, while operating in conjunction with the airline servers 220 managed by a plurality of domestic and foreign airlines being open for business through the GDS, and may transmit flight schedule data for one or more flights corresponding to a keyword in response to a request from the terminal support unit 310.

In particular, according to an embodiment of the present disclosure, other travel product data except golf course data are extracted based on places, persons, schedules, etc., which are matched with golf course data that are first selected by a user, and are presented to the user.

As components for implementing the aforementioned function, the airline interoperation unit 330 may include a flight schedule data collection module 331 that collects the hours of operations of flights including boarding times and flight schedule data including the number of passengers allowed to board in real time from one or more airline servers managed by airlines being open for business in each area or country, a flight schedule data provision module 333 that extracts one or more flight schedule data, among the collected flight schedule data, based on the schedule of selected golf course data and that provides the extracted flight schedule data to the user terminal 100 through the terminal support unit 310, and an airline ticket reservation module 335 that requests reservations from a corresponding airline server 220 when receiving a request for the reservations for any one flight from the user terminal 100 and receives the results of the reservations from the airline server 220.

The flight schedule data collection module 331 may collect flight schedule data including information on the sources and destinations of one or more flights registered with a plurality of airline servers, times and available persons for the one or more flights, etc. The collected flight schedule data may be stored in the database 360 for each airline.

The flight schedule data provision module 333 may provide the collected multiple flight schedule data to the user terminal 100 through the terminal support unit 310. In particular, according to an embodiment of the present disclosure, the flight schedule data provision module 333 may extract flight schedule data which may be automatically booked based on the place, date, and the number of persons for a currently selected golf course prior to search contents of a user, and may preferentially provide the flight schedule data to the user terminal 100.

In response thereto, the user can perform a reservation procedure of checking a flight which may be booked online.

When performing reservations, the airline ticket reservation module 335 may receive information on a flight, a time, and the number of persons, etc. that are selected by a user, may request reservations for an airline ticket by providing the information to the airline server 220, may receive the results of the reservations from the airline server 220, and may provide the results of the reservations to the user terminal 100 through the terminal support unit 310.

The other product interoperation unit 340 may provide a function for reserving a travel product including accommodations, vehicle rental, restaurants, etc. which need to be included in a travel schedule except the aforementioned golf course and airline ticket in association with the present golf trip case.

In order to provide the aforementioned function, the other product interoperation unit 340 may operate in conjunction with various supplier servers, such as a restaurant company server (not illustrated) including the accommodation company server 230 and the rental car company server 240, based on the GDS. Accordingly, the other product interoperation unit 340 may include one or more other modules 341 that implement a function for collecting travel product data and a function for reservations through the operations in conjunction therewith. The components of the modules of the other product interoperation unit 340 may correspond to the modules and functions that are mounted on the golf course interoperation unit 320 and the airline interoperation unit 330.

Furthermore, although not illustrated, travel products which may be provided through the other product interoperation unit 340 may further include reservations for attraction visits, such as a museum and an art museum, reservations for amusement park visits, etc.

The reservation processing unit 350 may execute a reservation process along with each supplier server 200 by using a GNR as a user who has completed the selection of all of travel products included in a travel schedule, including an airline ticket, an accommodation company, a rental car, a restaurant company, etc., in addition to a golf course actually requests reservations.

As components for implementing the aforementioned function, the reservation processing unit 350 may include a record update module 352 that sequentially records reservation histories on a GNR of a user who requests reservations when each interoperation unit receives a response to a reservation request, and an AI product recommendation module 354 that recommends suitable flight schedule data and travel product data to the user terminal 100 on the basis of a golf course selected with respect to a travel product which may be added to a travel schedule after selecting the golf course.

When a reservation case for a travel product occurs, the record update module 352 may check the GNR of a user who has requested reservations, and may sequentially record reservation histories on the data field thereof. The name and gender of a user, a golf course company name, a use date, a time, etc. may be recorded on the data field of the GNR. All of golf trip product reservations/use histories up to now from the first record generation timing may be recorded on the GNR. The system 300 may enable reservation cases for each user to be managed in a lump by enabling a reservation process to be processed in each supplier server 200 by using the GNR upon reservations of a travel product.

In particular, the present disclosure has an advantage in that a separate management/reservation number, etc. are not used for each travel products, but a user who checks product information booked through the supplier server 200 of an individual company not the system 300 of the present disclosure can make an inquiry to the supplier server 200 based on a GNR because the reservation histories of all of travel products are written in association with the GNR.

The AI product recommendation module 354 may provide a function for selecting a golf course and then recommending an optimal travel product to a user based on a travel schedule. Specifically, after a golf course is selected, if a flight is required for a movement from the source of a user to the golf course, the AI product recommendation module 354 may extract the data of an optimal flight having the shortest time from the database 360 by comprehensively considering the source and the location, distance, date, etc. of the golf course, that is, a destination, and may provide the data to the user terminal 100.

Furthermore, the AI product recommendation module 354 may extract the data of accommodations having the lowest price according to a minimum moving distance, means of transportation such as a rental car, a bus, or a taxi, restaurants having high taste evaluation, etc. according to a travel schedule on the basis of a golf course, and may provide the extracted data to the user terminal 100. In response thereto, a user can select and book a travel product according to the travel schedule except the golf course.

In particular, the AI product recommendation module 354 according to an embodiment of the present disclosure can extract and recommend reservation records and GPS information and more accurate and associated information according to the association and extension of a GNR-based network.

For example, assuming that “Chiang Mai The Royal Chiangmai Golf Resort September 1 AM 09:00” is selected and a golf trip reservation procedure is performed, the AI product recommendation module may extract “Chiang Mai moving time calculation”, “Chiang Mai, The Royal Chiangmai Golf Resort Breakfast”, “accommodations according to Chiang Mai, The Royal Chiangmai Golf Resort preference and distance”, “Chiang Mai, The Royal Chiangmai Golf Resort photo tasty restaurant association”, and “tourist attraction spot information for each Chiang Mai, The Royal Chiangmai Golf Resort time zone”, etc. through network association after generating a GNR, and may provide an accurate product recommendation service.

The database 360 may store golf course data, flight schedule data, accommodation company data, and other travel product data that are collected from the supplier servers 200 that operate in conjunction with the system in real time. In particular, the database may store a GNR for the management of a golf trip reservation case. The database 360 may provide the user terminal 100 with data extracted based on search contents.

Furthermore, various setting values, etc. for the management of the reservation system may be stored in the database 360. Information on search ranking, evaluation, etc. for travel products for each supplier, which are related to suppliers and disclosed in an external portal site, SNS, etc. in addition to the supplier server 200 may be also stored in the database.

In particular, the database 360 according to an embodiment of the present disclosure may include a travel information storage module 361 that stores all types of recordable travel information that are generated from the start to the end of a golf trip in association with a GNR and data storage module 363 that stores raw data generated in all of procedures related to a golf trip including travel information and the processed big data of the raw data.

Information that is managed by the travel information storage module 361 of the database 360 according to an embodiment of the present disclosure includes reservation records, golf tee time date and time information, GPS-based golf course location and country information, travel schedules, and user information including the names, gender, and contact information of users, encrypted information such as resident registration numbers, gender and group member composition information of participants for each reservation case, GPS-based golf round information, stored luggage information, extended information other than basic information, etc.

In particular, the aforementioned extended information is GNR-based affiliate network code information, and has been coded by combining GNR with additional information necessary for travel reservations along with the aforementioned basic information as the system 300 according to an embodiment of the present disclosure processes information based on the GNR. The aforementioned extended information is information that is obtained by combining and coding vehicle information, food (reservation) information, accommodation (reservation) information, SNS hash tags/photo information, tourist attraction spot information, etc. in the form of “GNR+information”.

Furthermore, the data storage module 363 collects and stores all of data that are generated according to the management of the golf travel service system 300, and may provide a data storage function associated with the big data system 400.

Furthermore, the AI golf trip service system 300 for the collection, processing, and distribution of big data according to another embodiment of the present disclosure may further include a learning unit 370 that extracts one or more travel products corresponding to the preference of each user based on travel information of the user, which is recorded in association with a GNR through a machine learning algorithm, and that provides the one or more travel products to the AI product recommendation module 354.

The learning unit 370 includes a learning model that calculates the preference of each user for a golf trip by using, as learning data, travel histories for golf courses, times, flights, accommodations, rental cars, restaurants, etc. which were previously used by users that are accumulated and recorded on a GNR. The learning unit extracts a suitable travel product based on preference that is calculated with respect to a corresponding user upon search of a golf course, flight, etc. of the user, and recommends the suitable travel product to the user.

For example, according to an embodiment of the present disclosure, the learning unit 370 may set weights with respect to a plurality of elements capable of specifying the preference of a user, such as total use times, average stay times, preferred use times, company locations, and a use for each time zone, in relation to golf courses, accommodations, rental cars, and restaurants that are recorded in association with the GNR of the user, and may preferentially calculate and recommend preference for each company.

Additionally, according to an embodiment of the present disclosure, a preference learning model may preferentially extract a travel product having high ranking or evaluation based on collected ranking, evaluation, etc. with respect to travel products from a portal site, SNS, etc. in addition to travel histories accumulated and recorded on a GNR, and may recommend the extracted travel product to a user.

Meanwhile, a big data system 400 that accumulates data related to massive golf trips according to system management and that uses the data may be further mounted on the AI golf trip service system 300 for the collection, processing, and distribution of big data according to an embodiment of the present disclosure. The big data system may serve, as big data, data are set and stored in association with a GNR.

Specifically, the big data system 400 may include a collection unit 410 that extracts raw data stored in the database 360 or the one or more supplier servers 200 in association with a GNR or receives the raw data by requesting the raw date, a processing unit 420 that generates distribution data having a tradable form by classifying, combining, and encrypting the collected raw data, and a distribution unit 430 that provides the distribution data to the one or more supplier servers 200 according to agreements depending on a transaction range.

The collection unit 410 may collect all of raw data that are generated according to the management of the golf trip service system 300. When a golf trip is booked, various types of information, such as a golf course, a flight, and accommodations selected in a reservation procedure, in addition to personal information of a user, are generated. The collection unit 410 may collect this information within the scope permitted by laws governing information collection and public disclosure, and may aggregate the collected data based on a GNR.

As components for performing such a function, the collection unit 410 may include a search module 411 that searches for and extracts raw data including one or more of user information, a golf tee time, and a golf course locations, and a GNR matching module 413 that collects, as the field of one GNR, anterior and posterior raw data that are collected by identifying the GNR set in association with the raw data.

The search module 411 may have various search functions, such as a keyword-based manual search function and an automatic search function using Crawler, mounted thereon. Accordingly, the search module may collect golf trip-related data from the supplier server 200 associated with the system in addition to the database 360 within the system.

Specifically, the search module 411 may collect a golf course location according to the GPSs, an encrypted schedule and traveler information of each travel case, gender, the number of group members, golf round GPS information, luggage storage information, etc. in addition to a tee time including a date and time with respect to a golf trip case.

The GNR matching module 413 may collect information collected by the search module 411 based on a GNR. According to an embodiment of the present disclosure, pieces of information that are collected as reservation information generated upon reservations along with each golf course and an airline is generated and stored based on the GNR, in addition to personal information of a user, may be standardized based on the GNR. The GNR matching module 413 may match the pieces of information by using the GNR as an identifier, and may record the collected information on a table field of the database 360.

The processing unit 420 may convert collected information in the form of data which may be used for analysis. In order to substantially use big data in a company, etc., a proper form is necessary for the big data, and noise, etc., may also need to be removed.

As components for performing such functions, the processing unit 420 may include a classification module 422 that classifies collected raw data according to data categories, a combination module 424 that generates one unit distribution data by combining a plurality of data that is classified as the same category and that is a minimum unit, and an encryption module 426 that performs encryption on one or more of a plurality of data pieces that form one unit distribution data.

The classification module 422 may standardize collected non-standardized data. For example, a golf trip reservation case includes information on a golf course, a airline, accommodations, etc. in addition to personal information of a user. The area, gender, and age of a user, the location, size, and price of a golf course, the boarding time and price of an airline, etc. may be sorted and classified for each category in information on multiple reservation cases.

Furthermore, the classification module 422 may execute a labeling process on classified data in addition to the aforementioned data classification process.

The combination module 424 may generate distribution data, that is, standardized data, by combining data classified for each category depending on purposes, such as learning data for deep learning or customer data for marketing in each company.

It is difficult to use raw data in deep learning, marketing, etc. because the raw data itself include a simple list of text information. Accordingly, after the raw data are classified, the raw data are standardized as a distributable data through a process of inputting associated information on a database table.

Such distribution data may be provided to the company side in a library or API form for deep learning.

The distribution unit 430 may provide an agreed supplier company with distribution data on which a processing process has been completed.

The distribution unit 430 for performing such function may include a public setting module 431 that determines whether to make public a plurality of distribution data depending on a preset public range and a distribution module 433 that transmits classified distribution data to a corresponding supplier server or provides a public API.

The public setting module 431 plays a role of determining whether to provide generated distribution data based on a public range set in the distribution data. Whether the distribution data may be made open to the public or provided to an external company depending on whether the distribution data include personal information or a question of assent, the characteristics of information, etc. is determined. When generating distribution data, the public setting module 431 may determine whether to provide the distribution data to the company side for each data by checking a preset public range.

The distribution module 433 may provide the supplier server with distribution data according to agreement contents. The golf trip service system according to an embodiment of the present disclosure may transmit distribution data accumulated within an agreed range to the supplier server 200 that is managed in each associated company.

Hereinafter, a golf trip reservation method by the AI golf trip service system for the collection, processing, and distribution of big data according to the present disclosure is described in detail with reference to the drawings.

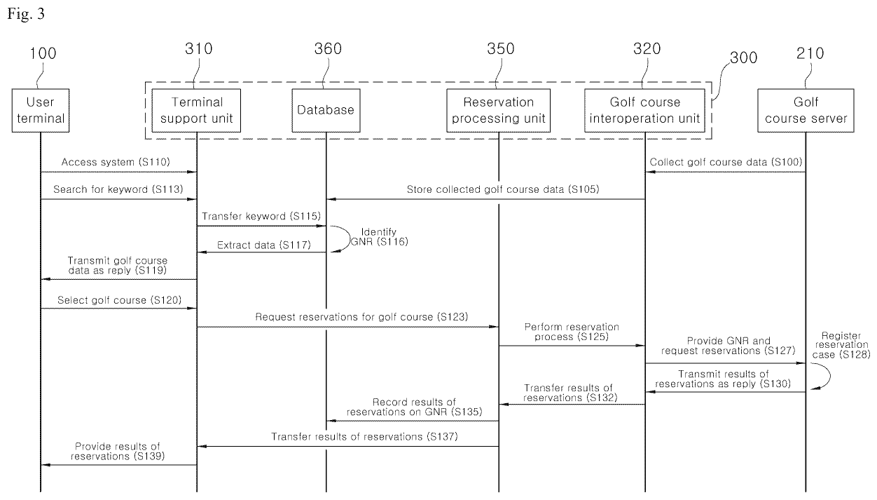

FIG. 3 is a diagram illustrating a golf trip reservation method by the AI golf trip service system for the collection, processing, and distribution of big data according to an embodiment of the present disclosure. In the following description, a golf course reservation procedure is representatively illustrated, but reservations for other travel products, such as an airline ticket and accommodations, may also be performed using the same procedure.

Referring to FIG. 3, according to the golf trip reservation method using the AI golf trip service system for the collection, processing, and distribution of big data according to an embodiment of the present disclosure, first, the golf course interoperation unit 320 of the system 300 operates in conjunction with the supplier server of an external travel product company, for example, the golf course server 210, and autonomously collects golf course data, that is, the data of a golf course product that is being served by the golf course server 210, in real time (S100). Furthermore, the golf course interoperation unit 320 may store the collected golf course data in the database 360 (S105).

Furthermore, a user who tries to prepare a golf trip by using the system of the present disclosure may access the system 300 by executing an application or web browser by using a smartphone, PC, or the like which is owned by the user (S110), and may search for a golf course to be booked by inputting a keyword related to the golf course (S113).

Accordingly, the terminal support unit 310 transfers the keyword that is input upon search of the user terminal 100 using the keyword (S113) to the database (360) a query form (S115). The database (360) identifies the GNR of a user (S116), and extracts one or more golf course data suitable for the user with reference to a golf trip history recorded on the data field of the GNR including the keyword (S117).

Next, the terminal support unit 310 transmits the extracted golf course data to the corresponding user terminal 100 as a reply (S119). The user terminal 100 displays the received golf course data on a screen.

Next, when the user selects any one golf course suitable for his or her intention, among the golf course data displayed on the screen of the user terminal 100 (S120), the terminal support unit 310 requests reservations for the golf course by transferring the results of the selection to the reservation processing unit 350 (S123).

In response thereto, the reservation processing unit 350 performs a golf course reservation process (S125), and requests reservation processing while providing the GNR of the reservation case to the corresponding golf course server 210 through the golf course interoperation unit 320 (S127).

In response to the request from the system 300, the golf course server 210 processes the golf course reservation case for the GNR on a reservation system that is autonomously managed, and registers a completed reservation case (S128). Next, the golf course server 210 transmits the results of the reservations to the system 300 as a reply.

Next, the reservation processing unit 350 of the system 300 receives the results of the reservations from the golf course interoperation unit 320 (S132), and records the reservation history on the data field of a corresponding GNR of the reservation case of the database 360 (S135).

Furthermore, the reservation processing unit 350 transfers the results of the reservations to the terminal support unit 310 (S137) so that the terminal support unit 310 can confirm the results of the reservations in the corresponding user terminal 100.

Thereafter, the user terminal 100 displays the results of the reservations on a screen. After confirming the results of the golf course reservations, the user may perform reservation procedures, such as an airline ticket, accommodations, a rental car, and a restaurant necessary for the remaining golf trip schedule.

Hereinafter, the AI golf trip service system for the collection, processing, and distribution of big data according to an embodiment of the present disclosure is described with reference to drawings.

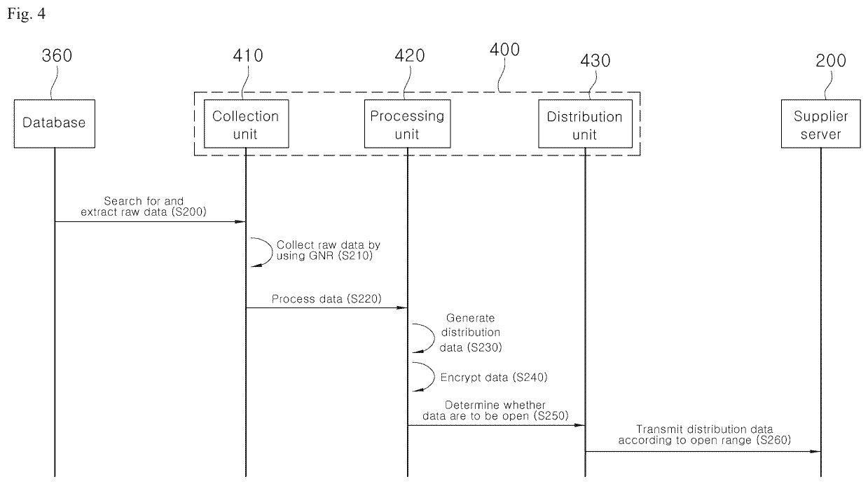

FIG. 4 is a diagram illustrating a method of collecting, processing, and distributing big data by the AI golf trip service system for the collection, processing, and distribution of big data according to an embodiment of the present disclosure.

Referring to FIG. 4, a big data processing procedure of the AI golf trip service system for the collection, processing, and distribution of big data according to an embodiment of the present disclosure is a step of searching for and extracting, by the collection unit 410 of the big data system 400 mounted on the golf trip service system, raw data that have not yet been processed from the database 360 as user information, travel information, etc. are accumulated and stored according to the management of the platform of the golf trip service system (S200). In this case, the collection unit 410 may collect raw data even from golf courses that sell golf trip products on the platform provided by the golf trip service system of the present disclosure and company servers that are managed by airlines, etc. through crawling in addition to the database within the system.

Next, the collection unit 410 collects the collected raw data by using a GNR as an identifier (S210). In an embodiment of the present disclosure, the raw data use a GNR that is assigned to a user as an identifier in procedures, such as the reservations, use, etc. of a golf trip product. Multiple raw data that are collected from the database 360, etc. are collected by using the GNR.

Next, the processing unit 420 performs a processing process of converting the collected information in the form of data which may be used in analysis (S220). The collected raw data include various types of information, such as reservations for a golf trip and a progress history up to the end of the trip, in addition to personal information of a user. Accordingly, the processing unit 420 may classify various types of information included in the raw data according to categories or may process the data by performing labeling.

Next, the processing unit 420 may generate standardized distribution data by combining the data classified for each category depending on several purposes, such as learning data for deep learning or the analysis of the preference of customers (S230), and can prevent the exposure of personal information, etc. by encrypting one or more data pieces that form each unit distribution data (S240). In such a step S240, a part of or the entire one unit distribution data may be encrypted and stored depending on the type of data.

Next, the distribution unit 430 checks a preset public range depending on whether personal information is included or a question of assent, the characteristics of information, etc. with respect to a plurality of distribution data stored in the system, and determines whether to provide the personal information (S250).

Furthermore, the distribution unit 430 provides the distribution data to a corresponding supplier server according to agreement contents (S260). In response thereto, the supplier server 200 may use the distribution data in the analysis of customer needs or marketing analysis as big data.

Hereinafter, the technical spirit of the present disclosure is described in detail through examples of screens that are provided by the AI golf trip service system for the collection, processing, and distribution of big data according to an embodiment of the present disclosure.

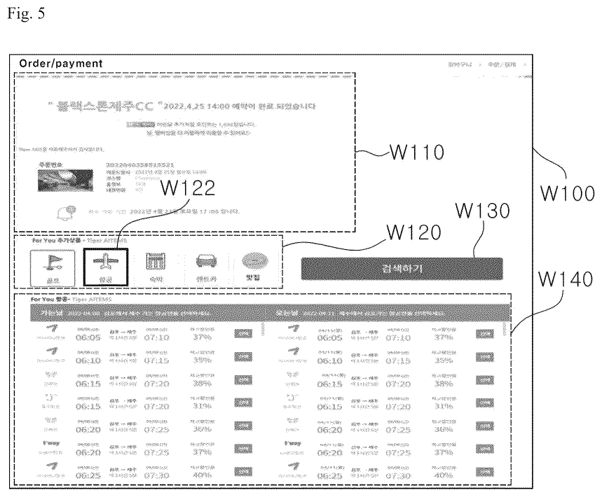

FIGS. 5 to 8 are diagrams that exemplify reservation screens that are provided to a user terminal by the AI golf trip service system for the collection, processing, and distribution of big data according to an embodiment of the present disclosure.

Referring to FIG. 5, the AI golf trip service system for the collection, processing, and distribution of big data according to an embodiment of the present disclosure provides a golf trip reservation service through an application or web browser that is installed and executed the user terminal, and may provide a web UI through which a travel product is searched for and selected and payment can be performed.

Specifically, a service window W100 may provide a UI through which a user may select a golf course, a flight, accommodations, a rental car, a restaurant, etc. which will be included in a travel schedule. According to the characteristics of the present disclosure, when a user first completes the selection of a golf course and reservations therefor (W110), the system may preferentially recommend optimal flight, accommodations, rental car, etc., which are associated with the selected golf course, by considering the place, time, the number of persons, etc. of the selected golf course,

As a travel product choice UI associated with the golf course, a travel product selection button W120 may be provided. When the user selects a flight icon W122 in the travel product selection button and presses a search button W130, the system may extract flight schedule data in the order of lowest price in which a discount rate has been considered based on a golf course schedule, a place, etc., among flight schedule data collected from airline servers, and may provide a flight list W140 to the user terminal.

In response thereto, the user may check a plurality of flights included in the flight list W140, may select a desired flight according to his or her intention, and may book an airline ticket.

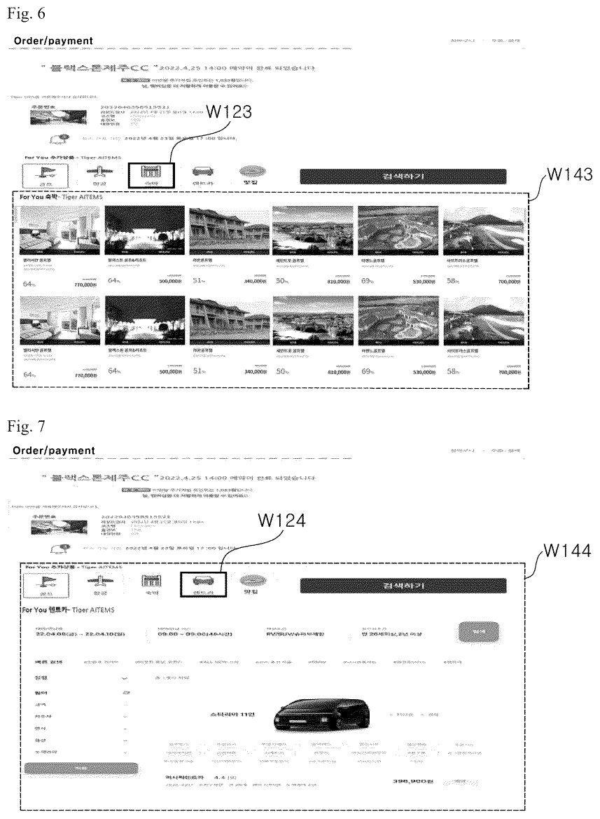

FIG. 6 illustrates an accommodation company selection screen that is provided by the system according to an embodiment of the present disclosure. After the reservations for the golf course, when the user selects an accommodation company icon W123, the system may collect accommodation company data from one or more registered accommodation company servers, may preferentially extract and list accommodation companies including accommodations, which are adjacent to the booked golf course and each have a size capable of accommodating the number of persons, among the collected accommodation company data, and may provide the accommodation companies to the user terminal.

In particular, the system according to an embodiment of the present disclosure is characterized in that a travel schedule is planned on the premise of a golf trip. Accordingly, an accommodation company having a form of a golftel that is most adjacent to a golf course selected by a user may be preferentially extracted and recommended. The user may select and book a desired accommodation company by considering the locations, prices, facilities, etc. of a plurality of accommodation companies included in the accommodation company list W143.

FIG. 7 illustrates a rental car reservation screen that is provided by the system according to an embodiment of the present disclosure. After the reservations for the golf course and the accommodations, the user may perform a reservation process for renting a rental car, that is, means of transportation, on the spot.

In such a rental car reservation process, a rental car may be searched for and booked earlier than accommodations. When the user selects a rental car icon W124, the system may extract and list the data of vehicles which may be taken over at the shortest distance and rental car companies that own corresponding vehicles, based on the location of the booked golf course, a location at an airport, the number of persons, etc., among rental car data collected from rental car company servers, and may provide the data to the user terminal.

In response thereto, the user may select and book a rental car company and a vehicle in a rental car list W144 depending on his or her intention by considering a travel schedule, the number of persons, etc.

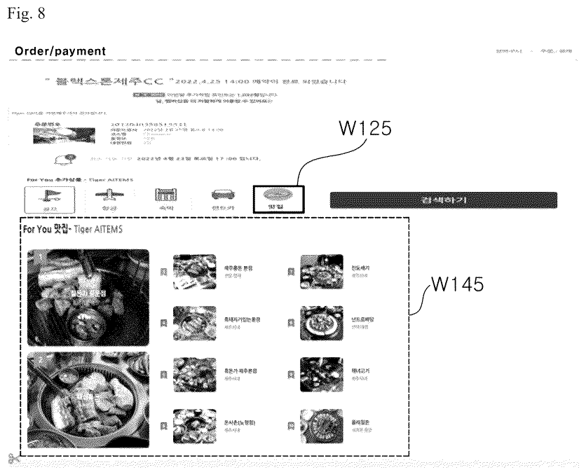

Furthermore, referring to FIG. 8, the system according to an embodiment of the present disclosure may provide a restaurant visit reservation function along with the accommodations, means of transportation, etc. according to the travel schedule. When the user selects a restaurant company (tasty restaurant) icon W125, among icons provided by the system, the system may collect restaurant company data from one or more registered restaurant company servers, may extract and list one or more restaurant company data that are present on the corresponding course according to the travel schedule that is booked up to now, and may provide the one or more restaurant company data to the user terminal.

In response thereto, the user may select and book a desired restaurant based on the schedule by considering the locations and prices of restaurants included in a restaurant company list W145 and comments, evaluation, etc. of other customers.

Although many contents have been described in detail in the description, such contents should be interpreted as an example of a preferred embodiment rather than limiting the scope of the disclosure. Accordingly, the present disclosure should not be determined by the aforementioned embodiments, but should be determined by the claims and equivalents of the claims.

1. An AI golf trip service system using big data, comprising:
a terminal support unit configured to receive a service request related to a golf trip in response to a request from one or more user terminals and to transmit a response to the request;
a golf course interoperation unit configured to collect golf course data, comprising one or more bookable golf course schedules, in real time from one or more golf course operating servers and to transmit one or more golf course data matched based on search of the user terminal;
an airline interoperation unit configured to collect flight schedule data, comprising one or more bookable flight schedules, in real time from one or more airline servers and to transmit one or more flight schedule data matched with golf course data selected by a user as a reply;
other product interoperation unit configured to collect travel products necessary for a travel destination in real time from one more travel product company servers and to transmit one or more travel product data matched with the golf course data or the flight schedule data selected by the user as a reply;
a reservation processing unit configured to generate one golf trip reservation process by combining one golf course data, one or more flight schedule data, or travel product data selected by the user; and
a database configured to store information related to a generated golf reservation process by using a golfer name record for each user as an identifier.

2. The AI golf trip service system of claim 1, wherein:
the user terminal accesses the terminal support unit through a user interface provided by an application or web page mounted thereon, and
the application comprises:
a search unit configured to request search from the terminal support unit through an input keyword and to receive results of the search related to one or more golf courses, flights, or travel products;
a reservation request unit configured to request reservations for one or more golf courses and other travel products other than the golf courses by transferring the selection of the user for the results of the search to the terminal support unit; and
reservation confirmation unit configured to request reservation completion details from the terminal support unit, receive a response to the request, and display the response, in response to a request from the user.

3. The AI golf trip service system of claim 1, wherein the golf course interoperation unit comprises:
a golf data collection module configured to collect the golf course data, comprising places, locations, available tee times, and a number of persons, from one or more golf course servers that are managed in golf courses being open for business in each area or country in real time;
a golf data provision module configured to provide the collected golf course data to the user terminal through the terminal support unit; and
a golf course reservation module configured to request reservations for a corresponding golf course server when reservations for any one golf course are requested by the user terminal and to receive results of the reservations from the golf course server.

4. The AI golf trip service system of claim 1, wherein the airline interoperation unit comprises:
a flight schedule data collection module configured to collect flight schedule data, comprising hours of operations of flights comprising boarding times and a number of passengers allowed to board, from one or more airline servers that are managed in airlines being open for business in each area or country in real time;
a flight schedule data provision module configured to extract one or more collected flight schedule data based on a schedule of the selected golf course data, among the collected flight schedule data, and to provide the extracted flight schedule data to the user terminal through the terminal support unit; and
an airline ticket reservation module configured to request reservations for a corresponding airline server when reservations for any one flight are requested by the user terminal and to receive results of the reservations from the airline server.

5. The AI golf trip service system of claim 1, wherein the reservation processing unit comprises:
a record update module configured to sequentially record reservation histories on the golfer name record of a user who requests reservations when each interoperation unit receives a response to a reservation request; and
an AI product recommendation module configured to recommend suitable flight schedule data and travel product data to the user terminal on the basis of a selected golf course with respect to a travel product that is able to be added to travel schedule after the golf course is selected.

6. The AI golf trip service system of claim 5, wherein the database comprises:
a travel information storage module configured to store travel information, comprising all of recordable histories that are generated from a start to an end of the golf trip, in the golfer name record by setting the travel information in association with the golfer name record; and
a data storage module configured to store raw data generated in all of procedures related to the golf trip comprising the travel information and big data obtained by processing the raw data.

7. The AI golf trip service system of claim 6, further comprising a learning unit configured to extract one more travel products corresponding to propensity information of each user based on travel information of the user, which is recorded in association with the golfer name record through a machine learning algorithm, and to provide the one or more travel products to the AI product recommendation module.

8. The AI golf trip service system of claim 1, further comprising a big data system configured to serve, as big data, data that are set and stored in association with the golfer name record, and
the big data system comprises:
a collection unit configured to extract raw data that are set and stored in association with the golfer name record from a database or one or more supplier servers or to receive the raw data by requesting the raw data;
a processing unit configured to generate distribution data having a tradable form by parsing, combining, and encrypting the collected raw data; and
a distribution unit configured to provide the distribution data to the one or more Supplier servers according to agreements based on a transaction range.

9. The AI golf trip service system of claim 8, wherein the collection unit comprises:
a search module configured to search for and extract the raw data comprising one or more of user information, a golf tee time, and a golf course location; and
a GNR matching module configured to identify the golfer name record set in association with the raw data and to collect anterior and posterior raw data collected as a field of one golfer name record.

10. The AI golf trip service system of claim 8, wherein the processing unit comprises:
a classification module configured to classify the collected raw data according to data categories;
a combination module configured to generate one unit distribution data by combining a plurality of data that are classified according to an identical category and that have a minimum unit; and
an encryption module configured to perform encryption on one or more of a plurality of data pieces that form one unit distribution data.

11. The AI golf trip service system of claim 8, wherein the distribution unit comprises:
a public setting module configured to determine whether to open a plurality of distribution data according to a preset public range; and
a distribution module configured to transmit the classified distribution data to a corresponding supplier server or to provide a public API.
